(19) United States
(12) Patent Application Publication
(10) Pub. No.: US 2021/0101463 A1
(43) Pub. Date: Apr. 8, 2021

(54) VEHICLE SUBSTRUCTURE

(71) Applicant: HONDA MOTOR CO., LTD., Tokyo (JP)

(72) Inventors: Yuki MATSUSHIMA, Wako-shi (JP); Chihiro SAKURADA, Wako-shi (JP); Koichi TAKAHASHI, Wako-shi (JP)

(21) Appl. No.: 17/062,810

(22) Filed: Oct. 5, 2020

(30) Foreign Application Priority Data
Oct. 3, 2019 (JP) 2019-182871

(51) Int. Cl. B60K 1/04; B62D 25/20; B62D 25/02

(52) U.S. Cl. CPC B60K 1/04; B60K 2001/0438; B62D 25/025; B62D 25/2036

(57) ABSTRACT

A vehicle substructure is capable of efficiently transmitting a load inputted from a front subframe or a front suspension mechanism. The vehicle substructure includes a battery case having a battery housed therein, wherein the battery case includes a bottomed case pan having an opening at a top thereof, and a case cover to close the opening of the case pan, wherein the battery caser is partly formed of a cast member which is arranged at a front end of the case cover and coupled to a rear end of the front subframe.

### CROSS-REFERENCE TO RELATED APPLICATION

This application claims the benefit of priority to Japanese Patent Application No. 2019-182871 filed on 3 Oct. 2019, the disclosures of all of which are hereby incorporated by reference in their entireties.

### TECHNICAL FIELD

The present invention relates to a substructure of a vehicle such as an electric vehicle.

### BACKGROUND OF THE INVENTION

A vehicle substructure is disclosed in Japanese Patent Application Publication No. 2016-52863 (hereinafter, referred to as Patent Document 1), for example, that includes a side sill (rocker) disposed on an outer side in a vehicle width direction of a floor panel and extending in a vehicle front-rear direction, and a floor cross member disposed on the floor panel and extending in the vehicle width direction.

The vehicle substructure disclosed in Patent Document 1 further includes a sub side sill (sub rocker) to couple the side sill with an end in the vehicle width direction of the floor cross member. Patent Document 1 describes that the sub side sill (sub rocker) is provided to effectively prevent the side sill (rocker), when a load of lateral collision has been inputted to the side sill, from collapsing inward in the vehicle width direction.

### SUMMARY OF THE INVENTION

### Problems to be Solved

Incidentally, when the vehicle substructure disclosed in Patent Document 1 is applied to a battery case, the invention of Patent Document 1 has difficulty in efficiently transmitting a load transmitted from a front subframe or a front suspension to the battery case.

The present invention has been made in view of the above-identified problem and is intended to provide a vehicle substructure capable of efficiently transmitting a load inputted from a front subframe or a front suspension mechanism.

### Solution to Problem

In order to achieve the above-described objective, the present invention provides a vehicle substructure including a battery case having a battery housed therein, wherein the battery case includes a bottomed case pan having an opening at a top thereof, and a case cover to close the opening of the case pan, wherein the case cover is partly formed of a cast member which is arranged at a front end of the case cover and coupled to a rear end of a front subframe.

### Advantageous Effects of the Invention

The present invention provides a vehicle substructure capable of efficiently transmitting a load inputted from a front subframe or a front suspension mechanism.

### BRIEF DESCRIPTION OF DRAWINGS

FIG. 1 is a bottom view of a vehicle having a vehicle substructure according to an embodiment of the present invention;

FIG. 2 is a lateral view of the vehicle in FIG. 1, partially cross-sectional in a vehicle front-rear direction;

FIG. 3 is a perspective view of the vehicle in FIG. 1, partially cutaway in the vehicle front-rear direction;

FIG. 4 is a perspective view of the vehicle in FIG. 1, partially cutaway in a vehicle width direction;

FIG. 5 is a top view of the vehicle in FIG. 1;

FIG. 6 is a bottom view of a case cover of a battery case;

FIG. 7 is a lateral view of the case cover in FIG. 6, partially cutaway in the vehicle front-rear direction;

FIG. 8 is a schematic cross-sectional view indicating a lateral collision load inputted to a side sill being transmitted inward in the vehicle width direction along the case cover;

FIG. 9 illustrates a load transmission path when a front collision load, a lateral collision load, or the like has been inputted in the present embodiment; and

FIG. 10 illustrates a load transmission path when a front collision load, a lateral collision load, or the like has been inputted in a related art studied by the present inventors.

### EMBODIMENTS OF THE INVENTION

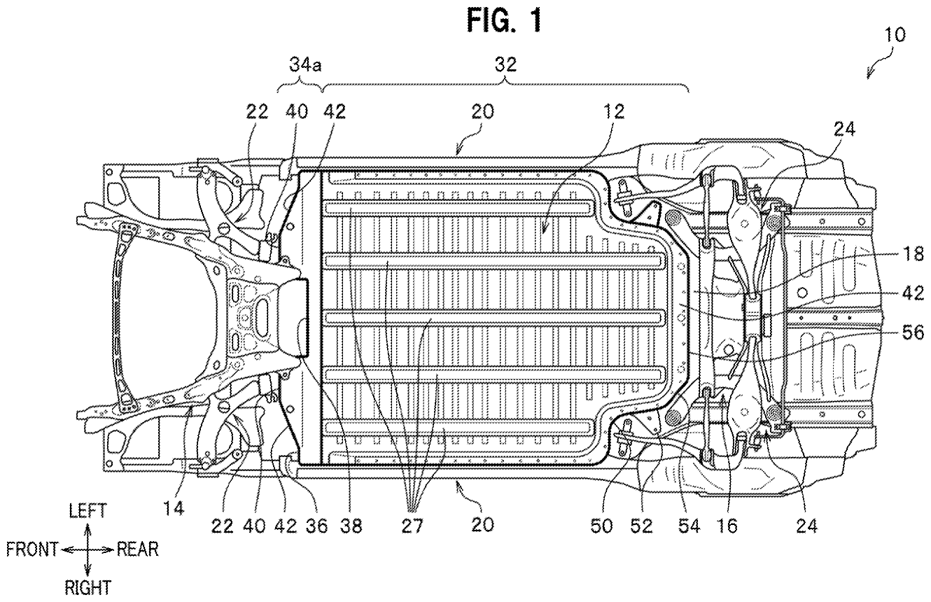

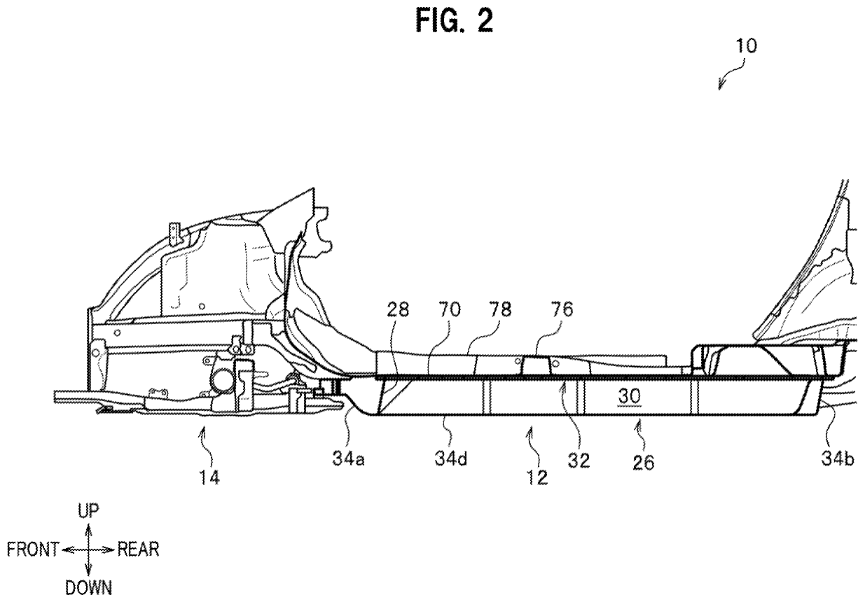

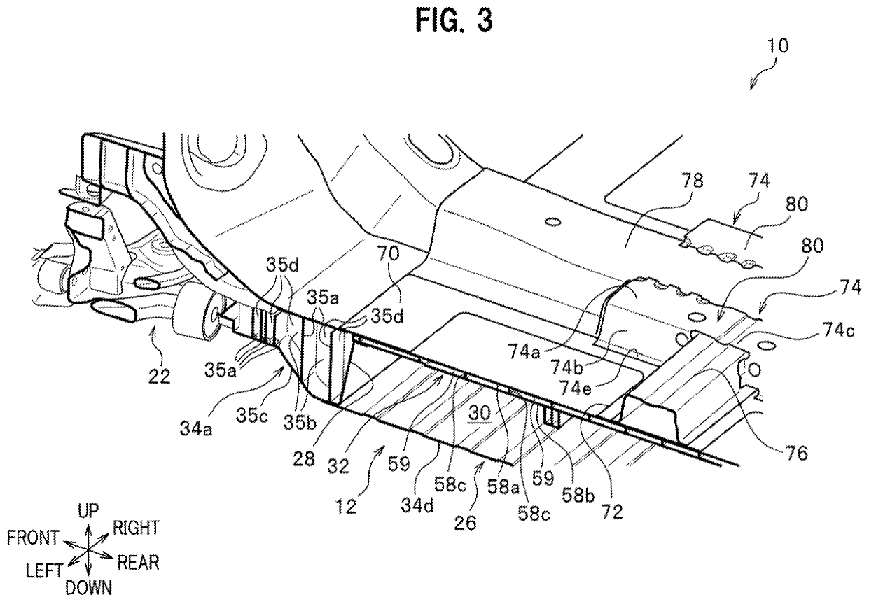

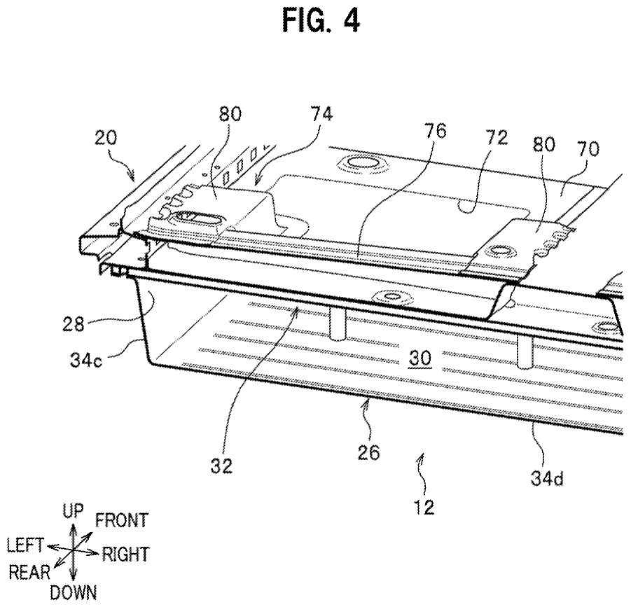

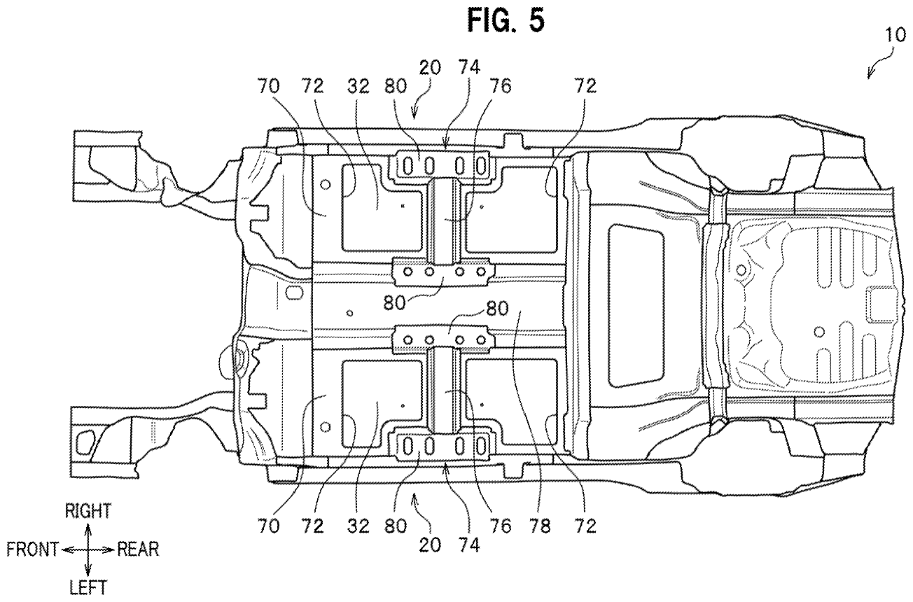

Hereinafter, an embodiment of the present invention is described in detail, with reference to the drawings as required. FIG. 1 is a bottom view of a vehicle having a vehicle substructure according to an embodiment of the present invention; FIG. 2 is a lateral view of the vehicle in FIG. 1, partially cross-sectional in a vehicle front-rear direction; FIG. 3 is a perspective view of the vehicle in FIG. 1, partially cutaway in the vehicle front-rear direction; FIG. 4 is a perspective view of the vehicle in FIG. 1, partially cutaway in a vehicle width direction; and FIG. 5 is a top view of the vehicle in FIG. 1.

Note that “front-rear” indicates the vehicle front-rear direction, “right-left” indicates the vehicle width direction (right-left direction), and “up-down” indicates a vehicle up-down direction (vertically up-down direction), respectively.

A vehicle substructure according to the embodiment of the present invention is applied to a vehicle 10 such as an electric vehicle, a hybrid vehicle, a fuel battery vehicle. The vehicle 10 includes a high-voltage battery (not shown), an electric motor (motor for travelling), and electric equipment such as a PDU (Power Drive Unit) to control and supply power from the battery to the electric motor.

The vehicle 10 includes a battery case 12 as an energy source for driving the electric motor, as shown in FIGS. 1 and 2. The battery case 12 is disposed under a center in the vehicle front-rear direction of the vehicle between a front subframe 14 and a rear subframe 16, in a bottom view. A front end, when installed in the vehicle, of the battery case 12 is coupled to a rear end, when installed in the vehicle, of the front subframe 14. A rear end, when installed in the vehicle, of the battery case 12 is coupled to a rear vehicle body 18 as a vehicle body member. Both ends in the vehicle width direction of the battery case 12 are respectively coupled to a pair of right and left side sills 20.

In addition, as shown in FIG. 1, a pair of right and left front suspension mechanisms 22 is disposed in front of the battery case 12, in the vehicle, on both sides in the vehicle width direction. Likewise, a pair of right and left rear suspension mechanisms 24 is disposed behind the battery case 12, in the vehicle, on both sides in the vehicle width direction. Note that the rear suspension mechanisms 24 are each configured as a trailing suspension including a trailing arm.

The battery case 12 includes a bottomed case pan 26 having an opening 28 at a top thereof, and a case cover 32 to close and seal the opening 28 of the case pan 26 to define a chamber 30, as shown in FIGS. 2 and 3. The chamber 30 of the battery case 12 houses a plurality of batteries (not shown). Note that FIG. 1 shows the battery case 12 with the case pan 26 removed, except a cast member 34a (to be described below), that is, the case cover 32 and the cast member 34a, as viewed from the bottom.

As shown in FIG. 2, the case pan 26 is formed to have a substantially rectangular shape, in a lateral view, and includes the cast member 34a at a front thereof in the vehicle, a rear wall 34b at a rear thereof in the vehicle, a pair of right and left side walls 34c (see FIG. 4) on both sides in the vehicle width direction thereof, and a bottom wall 34d to couple lower ends of the cast member 34a, rear wall 34b, and pair of right and left side walls 34c. The battery case 12 partly includes the cast member 34a.

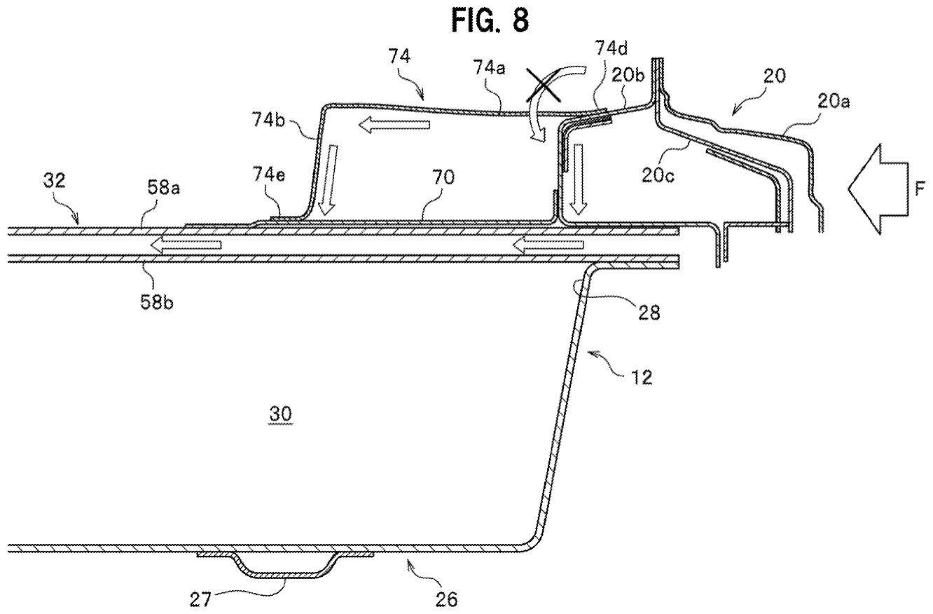

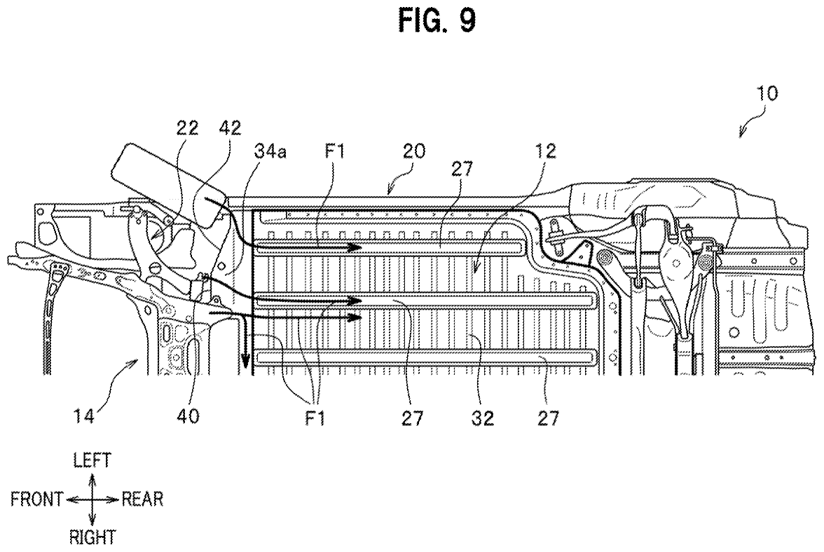

The case pan 26 has a plurality of reinforcing members 27 attached, in parallel with one another, to a lower surface thereof at the bottom (see FIGS. 1 and 9), in which the reinforcing member 27 is cross-sectionally in a hat shape in a front view (see FIG. 8) and extends in the vehicle front-rear direction.

The cast member 34a is disposed at a front end of the case cover 32, and is coupled to a rear end of the front subframe 14, as shown in FIG. 2. In addition, the cast member 34a extends in the vehicle width direction across both ends in the vehicle width direction of the battery case 12. Both ends in the vehicle width direction of the cast member 34a are coupled to the pair of right and left side sills 20, respectively. A top of a rear end of the cast member 34a continues to a front end of the case cover 32 via a stepped portion (see FIG. 2). The cast member 34a is made of a molded metal body having melted metal, such as iron and aluminum, poured into a mold (not shown) for molding.

As shown in FIG. 3, the cast member 34a constituting the front portion of the case pan 26 has hollow chambers 35d defined therein by lateral side walls 35a extending in the vehicle width direction, longitudinal side walls 35b extending in the vehicle front-rear direction, and a bottom wall 35c connecting bottoms of the lateral side walls 35a and bottoms of the longitudinal side walls 35b.

The case cover 32 is made of a plate in a flat plate shape formed with extrusion molding by an extruder (not shown), to have a substantially rectangular shape (see FIGS. 3 and 4) in a planar view. A front end of the case cover 32 abuts on a rear-side top edge of the cast member 34a to close the opening 28 of the case pan 26.

As shown in FIG. 1, the case cover 32 is formed, at a front end 36 thereof, with a recess 38 located at the center in the vehicle width direction and dented (set back) rearward. A pair of right and left protrusions 40, protruding frontward and coupled to the front suspension mechanism 22, are provided on both the right and left sides of the recess 38. Note that reference numerals 76, 78 indicate a vehicle body cross member and a center tunnel, respectively.

As shown in FIG. 1, the cast member 34a is provided with a pair of right and left skew portions 42 to continue to outer portions in the vehicle width direction of the protrusions 40. The skew portion 42 extends so as to skew outward in the vehicle width direction and rearward in the vehicle front-rear direction from an outer end in the vehicle width direction of a front edge of the protrusion 40.

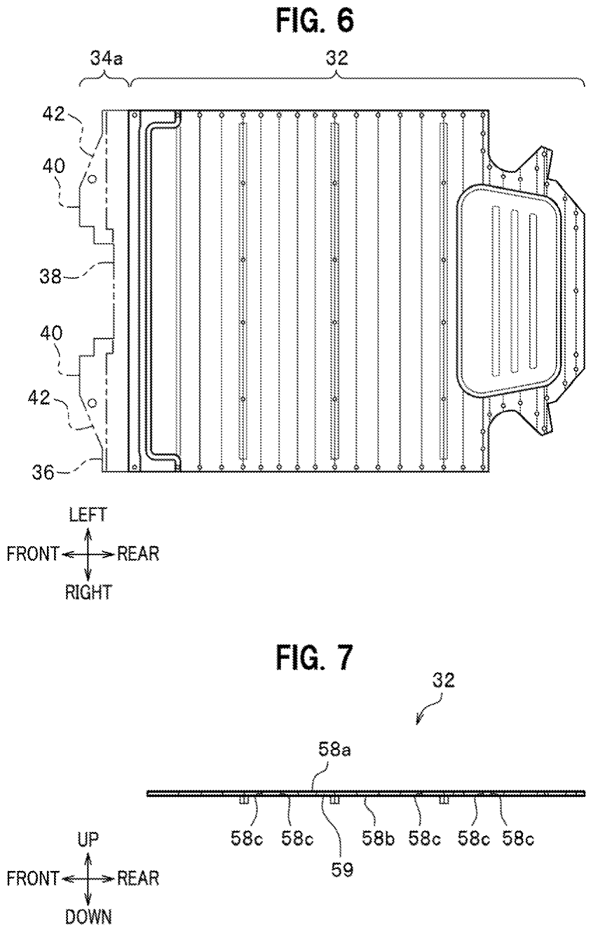

FIG. 6 is a bottom view of the case cover of the battery case, and FIG. 7 is a lateral view of the case cover in FIG. 6, partially cutaway in the vehicle front-rear direction.

As shown in FIG. 7, the case cover 32 has a sandwich structure in the up-down direction to have a top plate 58a located at a top thereof, a bottom plate 58b located at a bottom thereof, and partitions 58c to couple the top plate 58a with the bottom plate 58b. The partition 58c linearly extends in the vehicle width direction. The partitions 58c adjacent to each other in the vehicle front-rear direction define therebetween a hollow slit 59 (see FIGS. 3 and 7) to extend in the vehicle width direction. A distance between the adjacent partitions 58c varies in the vehicle front-rear direction. The top plate 58a and bottom plate 58b of the case cover 32 each have larger thicknesses at the front and rear ends thereof than a thickness at the center in the vehicle front-rear direction thereof.

In addition, a top surface of the case cover 32 has no such frames, that bulge upward, provided at front and rear edges and right and left edges thereof, to have a flat surface as with the rest thereof. That is, the top surface of the case cover 32 is flat at the front and rear edges and the right and left edges thereof.

Further, the case cover 32 has a floor panel 70 disposed on the top surface thereof, as shown in FIGS. 3 to 5. The floor panel 70 is provided with pan& openings 72 at part of areas vertically overlaying the case cover 32.

The vehicle 10 further includes the pair of right and left side sills 20, right and left seat frames 74, and the vehicle body cross members 76 to connect the pair of right and left side sills with each other, as shown in FIG. 5. The vehicle body cross member 76 has a hat shape in an axial cross section (see FIG. 3) and has bottom flanges on both sides thereof joined to the top surface of the floor pan& 70.

The side sills 20 are disposed on both the right and left sides in the vehicle width direction, and extend in the vehicle front-rear direction. As shown in FIG. 8, the side sill 20 includes an outer side sill 20a disposed on an outer side in the vehicle width direction, an inner side sill 20b disposed on an inner side in the vehicle width direction, and a side sill stiffener 20c interposed between the outer side sill 20a and the inner side sill 20b.

The seat frame 74 is disposed between the side sill 20 and the center tunnel 78, and extends in the vehicle front-rear direction across the vehicle body cross member 76, as shown in FIG. 5. The right and left seat frames 74 are disposed on the right and left sides in the vehicle width direction of the center tunnel 78 at the center, and each include a pair of frame members 80 facing each other in the vehicle width direction.

A vertical cross section of the seat frame 74 has a substantially L-shape (see FIG. 8 to be described below). The seat frame 74 includes a horizontal plate 74a extending substantially horizontally, and a vertical wall 74b curved at an inner end in the vehicle width direction of the horizontal plate 74a and extending downward. A center portion 74c in the vehicle front-rear direction of the horizontal plate 74a is joined to the vehicle body cross member 76. An outer end 74d in the vehicle width direction of the horizontal plate 74a is joined to the inner side sill 20b of the side sill 20. A lower end 74e of the vertical wall 74b is joined to a top surface of the floor panel 70.

The vehicle 10 having the vehicle substructure of the present embodiment is basically configured as described above, and advantageous effects thereof are described next. FIG. 8 is a schematic cross-sectional view indicating a lateral collision load inputted to the side sill being transmitted inward in the vehicle width direction along the case cover.

In the present embodiment, the case cover 32 is a plate in a flat plate shape formed with extrusion molding, and thus, when a lateral collision load F is inputted to the side sill 20, for example, the lateral collision load F is efficiently transmitted inward in the vehicle width direction along the case cover 32 having high rigidity and high strength (see FIG. 8). As a result, the rigidity and strength of the case cover 32 is more improved in the present embodiment than any prior art, to prevent the side sill 20 from being turned when the lateral collision load F is inputted.

In addition, in the present embodiment, a collision load (such as a front-collision load, a lateral collision load, and an offset load) inputted via the front suspension mechanism 22, the front subframe 14, or the right or left front wheel, for example, is transmitted to the cast member 34a (as a front end of the case pan 26) at the front end 36 of the battery case 12. The collision load transmitted to the cast member 34a is then transmitted rearward along the case cover 32 having high rigidity and high strength, and the case pan 26. The case cover 32 has a sandwich structure having the top plate 58a connected with the bottom plate 58b by the partitions 58c, to have high rigidity and high strength. Additionally, the case pan 26 is provided at the bottom thereof with reinforcing members 27 cross-sectionally in a hat shape in parallel in the vehicle front-rear direction. That is, in the present embodiment, a collision load is transmitted rearward so as to be dispersed by the cast member 34a. As a result, in the present embodiment, a collision load inputted from the front subframe 14, the front suspension mechanism 22, the right or left front wheel, or the like is efficiently directed to the battery case 12 and then absorbed. This allows for effective use of the battery case 12 as a structural member.

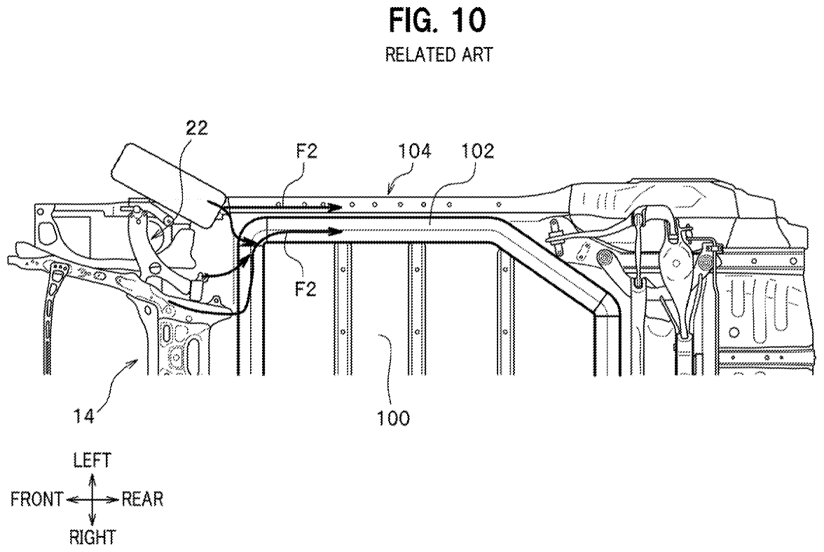

FIG. 9 illustrates a load transmission path of the present embodiment, when a front collision load, a lateral collision load, or the like has been inputted, and FIG. 10 illustrates a load transmission path of a related art studied by the present inventors, when a front collision load, a lateral collision load, or the like has been inputted. Note that in the related art in FIG. 10, there is no such a member that corresponds to the cast member 34a of the present embodiment, but a case cover 100 is provided on an outer periphery thereof with a frame 102 bulging along a peripheral edge thereof.

As shown in FIG. 9, in the present embodiment, a load F1 including a front collision load, a lateral collision load, a load inputted from the front subframe 14, and a load inputted from the front suspension mechanism 22 is transmitted to the cast member 34a at the front end 36 of the battery case 12. The load F1 transmitted to the cast member 34a having high rigidity is then transmitted to, and rearward in, the case cover 32 continuing to the rear end of the cast member 34a. In this manner, the load F1 including a front collision load and a lateral collision load is efficiently transmitted in the present embodiment to the case cover 32 via the cast member 34a.

In contrast, in the related art as shown in FIG. 10, a load F2 including a front collision load, a lateral collision load, a load inputted from the front subframe 14, and a load inputted from the front suspension mechanism 22 is transmitted rearward along a side sill 104 and/or a frame 102 on an outer side in the vehicle width direction of a case cover 100. That is, there is no such a member provided in the related art that receives and disperses a load, as with the cast member 34a of the present embodiment, to have a risk of having stress concentrated.

In addition, the cast member 34a of the present embodiment is coupled to the rear end of the front subframe 14. This allows for transmitting a collision load (including a front collision load, a lateral collision load, and an offset load) inputted via the front suspension mechanism 22, the front subframe 14, or the right or left front wheel, for example, in particular a collision load transmitted from the front subframe 14, to the battery case 12 via the cast member 34a at the front end 36 of the battery case 12 (as the front end of the case pan 26), to suitably absorb the collision load.

Further, the cast member 34a of the present embodiment protrudes frontward to have a pair of the right and left protrusions 40 to be coupled to the front suspension mechanism 22. This allows for transmitting a collision load (including a front collision load, a lateral collision load, and an offset load) inputted via the front suspension mechanism 22, the front subframe 14, or the right or left front wheel, for example, in particular a collision load transmitted from the front suspension mechanism 22, to the battery case 12 via the protrusions 40 at the front end 36 of the battery case 12, to suitably absorb the collision load.

Still further, the cast member 34a of the present embodiment has the skew portions 42 extending outward in the vehicle width direction and rearward in the vehicle front-rear direction from the outer end in the vehicle width direction of the front edge of the protrusions 40. This allows for transmitting a collision load (including a front collision load, a lateral collision load, and an offset load) inputted via the front suspension mechanism 22, the front subframe 14, or the right or left front wheel, for example, in particular a lateral collision load or an offset load, to the battery case 12 via the skew portions 42 of the cast member 34a, to efficiently absorb the collision load.

Still further, the battery case 12 of the present embodiment is coupled at both ends in the vehicle width direction thereof to the pair of right and left side sills 20, respectively. The cast member 34a extends in the vehicle width direction across both ends in the vehicle width direction of the battery case 12. This allows the cast member 34a provided so as to extend in the vehicle width direction between the pair of right and left side sills 20 to suitably reinforce rigidity and strength of vehicle body members.

Still further, the case pan 26 of the present embodiment is provided at the bottom thereof with the reinforcing members 27 cross-sectionally in a hat shape as viewed from the front and extending in the vehicle front-rear direction. This allows for improving rigidity and strength in the vehicle front-rear direction of the case pan 26 to suitably absorb a load in the vehicle front-rear direction transmitted via the cast member 34a.

Still further, the case cover 32 of the present embodiment has, in the up-down direction, the top plate 58a located at the top thereof, the bottom plate 58b located at the bottom thereof, and the partitions 58c disposed between the top plate 58a and the bottom plate 58b to couple the top plate 58a with the bottom plate 58b. The case cover 32 of the present embodiment has a sandwich structure including the top plate 58a, the bottom plate 58bf, and the partitions 58c, to improve rigidity and strength of the case cover 32 against a horizontal load to suitably absorb a load in the vehicle front-rear direction transmitted via the cast member 34a.

Still further, the case cover 32 of the present embodiment has larger thicknesses at the front and rear ends of the top plate 58a and bottom plate 58b than those at the center in the vehicle front-rear direction thereof. In the present embodiment, the case cover 32 having larger thicknesses at the front and rear ends of the top plate 58a and bottom plate 58b than a thickness at the center in the vehicle front-rear direction thereof allows for improving rigidity and strength of the case cover 32 at the front and rear ends thereof to let a collision load inputted from in front of, or behind, the battery case 12 efficiently transmitted to the battery case 12 for absorption. As a result, the battery case 12 of the present embodiment is effectively utilized as a structural member.

Still further, the cast member 34a of the battery case 12 also serves as a member to reinforce rigidity and strength of vehicle body members, in the present embodiment. This allows the cast member 34a to reinforce rigidity and strength of vehicle body members of the vehicle substructure, disposed behind the front subframe 14 in the vehicle front-rear direction. In other words, a frame of the vehicle body, which requires higher rigidity and strength than other members, is partly compensated with the cast member 34a of the battery case 12.

Still further, the load F1 inputted from a front portion or a lateral portion of the vehicle is transmitted in the present embodiment to the case cover 32 via the cast member 34a, to suitably absorb the load F1.

### LIST OF REFERENCE SIGNS

10: vehicle, 12: battery case, 14: front subframe, 22: front suspension mechanism, 26: case pan, 27: reinforcing member, 28: opening, 30: chamber, 32: case cover, 34a: cast member, 40: protrusion, 42: skew portion, 58a: top plate, 58b: bottom plate, 58c: partition, and F1, F2: load.

What is claimed is:

1. A vehicle substructure comprising a battery case having a battery housed therein,
wherein the battery case includes a bottomed case pan having an opening at a top thereof, and a case cover to close the opening of the case pan,
wherein the battery case is partly formed of a cast member which is arranged at a front end of the case cover and coupled to a rear end of a front subframe.

2. The vehicle substructure as claimed in claim 1, wherein
the cast member protrudes frontward to have a pair of protrusions to be coupled to a front suspension mechanism.

3. The vehicle substructure as claimed in claim 2, wherein
the cast member has a skew portion extending outward in a vehicle width direction and rearward in the vehicle front-rear direction from an outer end in the vehicle width direction of a front edge of the protrusion.

4. The vehicle substructure as claimed in claim 1, wherein
the battery case is coupled at both ends in the vehicle width direction thereof to a pair of right and left side sills, respectively, and
the cast member extends in the vehicle width direction across both ends in the vehicle width direction of the battery case.

5. The vehicle substructure as claimed in claim 1, wherein
the case pan is provided at a bottom thereof with reinforcing members cross-sectionally in a hat shape as viewed from the front and extending in the vehicle front-rear direction.

6. The vehicle substructure as claimed in claim 1, wherein
the case cover has, in an up-down direction, a top plate located at a top thereof, a bottom plate located at a bottom thereof, and partitions disposed between the top plate and the bottom plate to couple the top plate with the bottom plate.

7. The vehicle substructure as claimed in claim 6, wherein
the case cover has larger thicknesses at a front end and a rear end of the top plate and bottom plate than a thickness at a center in the vehicle front-rear direction thereof.
